(19) United States
(12) Patent Application Publication
(10) Pub. No.: US 2007/0138446 A1
(43) Pub. Date: Jun. 21, 2007

(54) Nickel powder and method of producing the same

(75) Inventor: Akihide Furukawa, Ueda-shi (JP)

Correspondence Address: BIRCH STEWART KOLASCH & BIRCH, PO BOX 747, FALLS CHURCH, VA, 22040-0747, US

(73) Assignee: Shinano Kenshi Kabushiki Kaisha

(21) Appl. No.: 11/640,848

(22) Filed: Dec. 19, 2006

(30) Foreign Application Priority Data
Dec. 20, 2005 (JP) 2005-366355
Nov. 22, 2006 (JP) 2006-316097

(51) Int. Cl. H01B 1/22; C22C 1/04

(52) U.S. Cl. 252/513; 419/23

(57) ABSTRACT

The nickel powder includes nickel particles, in each of which stabber-shaped projections are integrally formed on an outer surface. The nickel particles have diameters of 0.1-10 μm. Each of the nickel particles comprises: an outer surface; and a large number of stabber-shaped projections, whose heights are lower than a quarter (¼) of the particle diameter, being integrally formed on the outer surface.

### BACKGROUND OF THE INVENTION

The present invention relates to nickel power and a method of producing nickel powder, more precisely relates to nickel powder including nickel particles, each of which has stabber-shaped projections, and a method of producing the nickel powder.

Nickel powder, which includes spherical nickel particles having diameters of several pm, is mixed with resin or resin paste, as filler, so as to gain electrical conductivity. To improve electrical conductivity, the spherical nickel particles are coated with a noble metal, e.g., silver. To further improve electrical conductivity of the filler, surfaces of the spherical nickel particles are coated with silver, and then the spherical nickel particles are dried in a fixed temperature tank for several days so as to form projections (see Japanese Patent No. 3656274).

Conventionally, nickel powder is produced by a carbonyl process, an atomize process, a CVD process or an oxidation-reduction process. In the oxidation-reduction process, an alkaline aqueous solution of nickel salt is heated with adding hydrazine hydrate thereto so as to perform reduction, so that nickel particles, which are formed into spherical shapes and have diameters of submicrometer to several μm, can be reduced (see Japanese Patent Gazette No. 9-291318).

In the generally used carbonyl process, atomize process and oxidation-reduction process, nickel particles are formed into spherical shapes and have smooth surfaces. Therefore, in a composite material constituted by resin and the nickel particles, the nickel particles cannot firmly adhere to the resin. The adjacent nickel particles mutually contact at only one point, so improving electrical conductivity is limited. Further, the surfaces of the silver-plated surfaces of the nickel particles may be roughened by alkali treatment, but production steps must be undesirably increased.

### SUMMARY OF THE INVENTION

The present invention was conceived to solve the above described problems.

An object of the present invention is to provide nickel powder including nickel particles, in each of which stabber-shaped projections are integrally formed on an outer surface.

Another object is to provide a composite material including said nickel powder.

Further object is to provide a method of producing said nickel powder.

To achieve the objects, the present invention has following structures.

Namely, the nickel powder of the present invention includes nickel particles, whose particle diameters are 0.1-10 μm, and

each of said nickel particles comprises:

an outer surface; and

a large number of stabber-shaped projections, whose heights are lower than a quarter (¼) of the particle diameter, being integrally formed on the outer surface.

In the nickel powder, the outer surface of each of the nickel particles may be coated with a metal film.

The composite material of the present invention comprises:

matrix resin; and

the nickel powder the present invention mixed with the matrix resin.

Further, the method of producing nickel powder, which includes nickel particles, comprises the steps of:

producing base liquid, in which a nickel compound is included as a nickel source;

producing an alkaline liquid by adding alkali and at least one member selected from a group consisting of a sulfate ion source, an ammonia or ammonium ion source, a nitrate ion source and a complexing agent for producing a complex body with nickel to the base liquid; and

reducing nickel particles by warming the alkaline liquid and adding a reducing agent constituted by hydrazine or hydrazine hydrate so as to form the nickel particles, in each of which a large number of stabber-shaped projections are integrally formed on an outer surface.

At least one member selected from a group consisting of a sulfate ion source, an ammonia or ammonium ion source, a nitrate ion source and a complexing agent for producing a complex body with nickel can be added after alkali addition.

Or at least one member selected from a group consisting of a sulfate ion source, an ammonia or ammonium ion source, a nitrate ion source and a complexing agent for producing a complex body with nickel can be added before alkali addition.

Or at least one member selected from a group consisting of a sulfate ion source, an ammonia or ammonium ion source, a nitrate ion source and a complexing agent for producing a complex body with nickel can be added before and after alkali addition.

Or alkali can be added before and after at least one member selected from a group consisting of a sulfate ion source, an ammonia or ammonium ion source, a nitrate ion source and a complexing agent for producing a complex body with nickel.

Or the alkaline liquid is produced by firstly adding at least one member selected from a group consisting of a sulfate ion source, an ammonia or ammonium ion source, a nitrate ion source and a complexing agent for producing a complex body with nickel to the base liquid and further adding alkali thereto, and repeating said two adding processes in that order.

Or the alkaline liquid is produced by firstly adding alkali to the base liquid and further adding at least one member selected from a group consisting of a sulfate ion source, an ammonia or ammonium ion source, a nitrate ion source and a complexing agent for producing a complex body with nickel thereto, and repeating said two adding processes in that order.

Preferably, metal powder or ceramic powder is mixed with the base liquid.

Preferably, a carbonate ion source is added to the base liquid.

Further, the complexing agent may be boric acid, EDTA or glycine.

By employing the present invention, the nickel powder including the nickel particles, in each of which the stabber-shaped projections are integrally formed on the outer surface, can be provided. By mixing the nickel powder with the matrix resin to produce the composite material, each of the stabber-shaped projection contacts other stabber-shaped projections, so that electrical conductivity of the composite material can be improved.

### BRIEF DESCRIPTION OF THE DRAWINGS

Embodiments of the present invention will now be described by way of examples and with reference to the accompanying drawings, in which:

FIG. 1 is an electron micrograph of nickel powder produced as Example 1;

FIG. 2 is an electron micrograph of nickel powder produced as Example 2;

FIG. 3 is an electron micrograph of nickel powder produced as Example 3;

FIG. 4 is an electron micrograph of nickel powder produced as Example 4;

FIG. 5 is an electron micrograph of nickel powder produced as Example 5;

FIG. 6 is an electron micrograph of nickel powder produced as Example 6;

FIG. 7 is an electron micrograph of nickel powder produced as Example 7;

FIG. 8 is an enlarged photograph of the nickel powder produced as Example 7;

FIG. 9 is an electron micrograph of nickel powder produced as Example 8;

FIG. 10 is an electron micrograph of nickel powder produced as Example 9; and

FIG. 11 is an electron micrograph of nickel powder produced as Example 10.

### DETAILED DESCRIPTION OF THE EMBODIMENTS

Preferred embodiments of the present invention will now be described in detail with reference to the accompanying drawings. As described above, the method of producing the nickel powder of the present invention, which includes nickel particles, comprises the steps of: producing base liquid, in which a nickel compound is included as a nickel source;

producing an alkaline liquid by adding alkali and at least one member selected from a group consisting of a sulfate ion source, an ammonia or ammonium ion source, a nitrate ion source and a complexing agent for producing a complex body with nickel to the base liquid; and

reducing nickel particles by warming the alkaline liquid and adding a reducing agent constituted by hydrazine or hydrazine hydrate so as to form the nickel particles, in each of which a large number of stabber-shaped projections are integrally formed on an outer surface.

Nickel salts, e.g., nickel chloride, nickel sulfate, and other nickel compounds having a following chemical formula CM1, e.g., basic nickel carbonate, may be used as the nickel source.
CM1: xNiCO₃.yNi(OH)₂.zH₂O

The nickel compound may be used solely or together with another nickel compound(s).

The pH value of the base liquid is adjusted by alkali. Preferably, NaOH is used as alkali, but it is not limited. In a reduction process of nickel with hydrazine, concentration of alkali, which acts as a hydroxide ion source, must be higher than a prescribed concentration, and a proper pH value of the alkaline liquid is 10 or more. Particle diameters of nickel particles can be controlled by the pH value of the liquid. Therefore, the pH value is controlled on the basis of an object particle diameter of the nickel particles.

Since alkali is consumed by the reductive reaction of hydrazine, hydroxide ions in the liquid are reduced. If hydroxide ions in the liquid are dramatically reduced, the proper pH value of the liquid cannot be maintained. Thus, alkali may be added to the liquid during the reaction.

A proper amount of hydrazine hydroxide defined as contained hydrazine is 1-20 mol with respect to 1 mol of nickel in the liquid.

Preferably, reaction temperature is maintained at 50-70 □ so as to efficiently react the hydrazine hydroxide.

By adding sulfate ions, ammonia or ammonium ions and/or nitrate ions in the base liquid, the nickel particles, which are reduced and deposited by adding hydrazine or hydrazine oxide and each of which has a large number of stabber-shaped projections on an outer surface, are produced. The reason of forming the stabber-shaped projections is uncertain.

Note that, at least one kind of ions selected from sulfate ions, ammonia or ammonium ions and nitrate ions are included in the base liquid.

Preferably, a minute amount of metal powder (e.g., nickel powder, palladium powder), metal ions, metal oxide, ceramic powder, organic powder and/or inorganic powder may be previously added to the base liquid. We think that the metal powder, etc. accelerate the reductive reaction, in which nickel ions in the base liquid is reduced and deposited as nickel particles, as a catalytic agent, cores or seeds.

Sulfate salts, e.g., sodium sulfate, potassium sulfate, may be used as the sulfate ion source besides sulfuric acid. In the presence of sulfate ions, the reductive reaction relatively stably proceeds. An amount of the sulfate ion source defined as concentrated sulfuric acid is 10 mol or less, preferably 6 mol or less, with respect to 1 mol of nickel. If the amount of concentrated sulfuric acid is more than 10 mol with respect to 1 mol of nickel, a large amount of alkali must be undesirably required.

Ammonia water and ammonium salts, e.g., ammonium chloride, may be used as the ammonia or ammonium ion source. An amount of the ammonia or ammonium ion source defined as concentrated ammonia water is 20 mol or less, preferably 10 mol or less, with respect to 1 mol of nickel. If the amount of concentrated ammonia water is more than 20 mol with respect to 1 mol of nickel, deposited nickel particles will adhere each other or will form into a plate-shape. Namely, the desired nickel particles cannot be gained.

Nitrate salts, e.g., sodium nitrate, potassium nitrate, may be used as the nitrate ion source besides nitric acid. In the presence of nitrate ions, the reductive reaction takes a long time, but it is improper to add a large amount of nitrate ions, which exceed a prescribed amount. Therefore, the amount of the nitrate ion source defined as concentrated nitric acid is 10 mol or less, preferably 6 mol or less, with respect to 1 mol of nickel. If the amount of concentrated sulfuric acid is more than 10 mol with respect to 1 mol of nickel, a large amount of alkali must be undesirably required.

By adding sulfate ions, or ammonia or ammonium ions in the base liquid, nickel particles become fine particles, which have uniform diameters of submicrometer. On the other hand, in the presence of nitrate ions, nickel particles become coarse particles, which are relatively large and have diameters of several μm. Further, their particle diameters are dispersed.

Therefore, nickel particles having an object diameter can be produced by controlling the amounts of sulfate ions, ammonia or ammonium ions and nitrate ions, i.e., the ion sources.

By controlling the amounts of sulfate ions, ammonia or ammonium ions and nitrate ions and the pH value, nickel particles, whose a center part range of normal distribution of diameters is 0.1-10 μm, can be produced.

Sizes of stabber-shaped projections are small, and their heights are lower than a quarter (¼) of the particle diameter. The projections are formed like quadrangular pyramids, circular cones, etc. A large number of the stabber-shaped projections are thickly and integrally formed on an outer surface of each spherical nickel particle. Since the stabber-shaped projections are micro fine projections, a surface area of each nickel particle is highly broadened.

Further, additive agents for stabilizing and accelerating the reductive reaction may be added.

Carbonate compounds, e.g., sodium carbonate, are the suitable additive agents. A proper amount of sodium carbonate is 10 mol or less, preferably 3 mol or less, with respect to 1 mol of nickel. When a large amount of ammonium ions, which contribute to form the stabber-shaped projections, exist, the ammonium ions perform pH-buffering action with carbonate ions. Note that, carbonate ions restrain diameter dispersion of the nickel particles and work to uniformly form the stabber-shaped projections, we think.

Glycine, EDTA, citric acid compounds, boric acid, etc. may be used as complexing agents for forming complex bodies with nickel. An amount of the complexing agent is not limited, but a proper amount of the complexing agent is 10 mol or less, preferably 5 mol or less, with respect to 1 mol of nickel. If the amount of the complexing agent is more than 10 mol with respect to 1 mol of nickel, a time period of depositing nickel will be longer so that production efficiency must be lower.

The nickel powder produced by the above described method is mixed with matrix resin so as to produce an electrically conductive resin, which is one of composite materials. The matrix resin is not limited. Since the nickel powder of the above described embodiment includes the nickel particles, in each of which the stabber-shaped projections are formed on the outer surface thereof, each of the stabber-shaped projections can contact the adjacent stabber-shaped projections at a plurality of points. Therefore, electrical conductivity of the composite material can be improved. By the stabber-shaped projections, the matrix resin can firmly adheres to the nickel particles so that strength of the composite material can be improved.

To further improve electrical conductivity, surfaces of the nickel particles may be coated with a noble metal, e.g., silver, gold, platinum, by sputtering, a CVD process, etc.

Successively, experimental examples will be explained.

### EXAMPLE 1

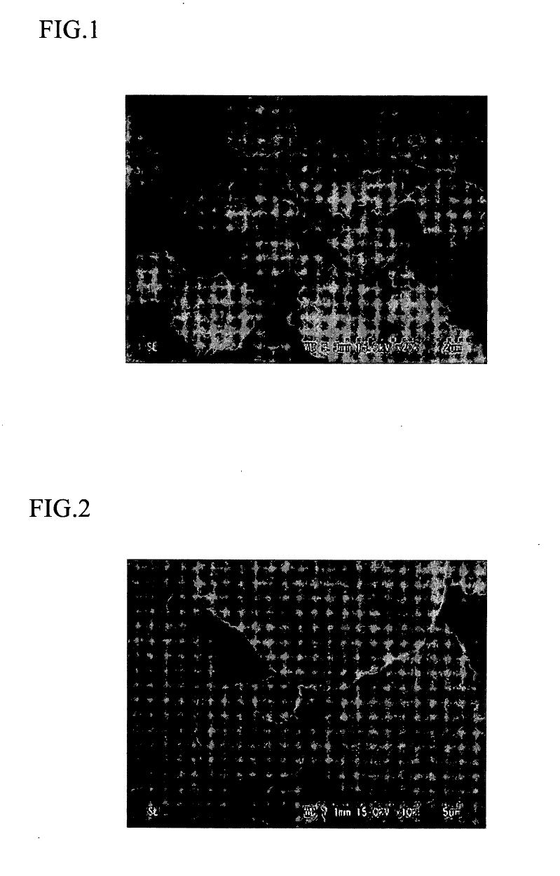

Base liquid including 50 ml of ion-exchange water and 4 g of nickel chloride hexahydrate was firstly prepared. Next, 1 ml of concentrated sulfuric acid was added to the base liquid, and an amount of NaOH was adjusted so as to adjust a pH value of the base liquid to about pH 12 with pH test paper (trade name: DUOTEST pH9.5-14), so that an alkaline liquid was produced. The liquid was stored in an oil bath and maintained at temperature about 60 □, and 3 ml of hydrazine hydrate was added for the reductive reaction. The reductive reaction was terminated within five hours, and the nickel powder including the nickel particles, in each of which a large number of the relatively long stabber-shaped projections were thickly formed on the outer surface, was produced. An electron micrograph of the produced nickel powder is shown in FIG. 1. Particle size distribution of the nickel particles was 0.2-2 μm.

### EXAMPLE 2

Base liquid including 50 ml of ion-exchange water and 6 g of basic nickel carbonate was firstly prepared. Next, 1 ml of concentrated sulfuric acid was added to the base liquid, and an amount of NaOH was adjusted so as to adjust a pH value of the alkaline liquid to about pH 12 with pH test paper (trade name: DUOTEST pH9.5-14), so that an alkaline liquid was produced. The alkaline liquid was stored in an oil bath and maintained at temperature about 60 □, 6 ml of hydrazine hydrate was added. The reductive reaction was performed with adding NaOH so as to maintain the pH value 10 or more. The reductive reaction was terminated within 10 hours, and the nickel powder including the nickel particles, in each of which a large number of the relatively small stabber-shaped projections were thickly formed on the outer surface, was produced. An electron micrograph of the produced nickel powder is shown in FIG. 2.

### EXAMPLE 3

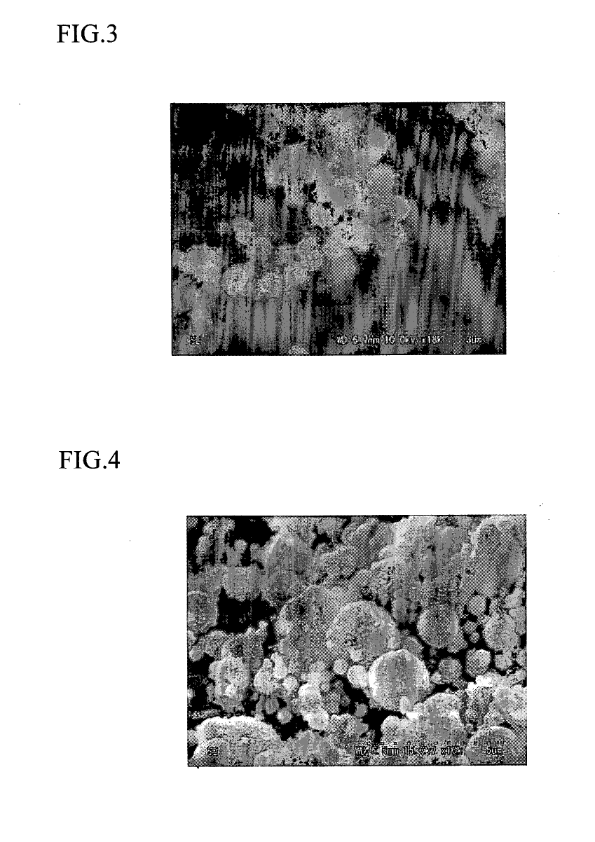

Base liquid including 25 ml of ion-exchange water and 2 g of nickel chloride hexahydrate was firstly prepared. Next, NaOH was added to the base liquid so as to adjust a pH value of the base liquid to about pH 12 with pH test paper (trade name: DUOTEST pH9.5-14). Further, 2 ml of concentrated ammonia water was added, so that an alkaline liquid was produced. Then, the alkaline liquid was stored in an oil bath and maintained at temperature about 60 □, and 4 ml of hydrazine hydrate was added for the reductive reaction. The reductive reaction was terminated within five hours, and the nickel powder including the nickel particles, in each of which a large number of the stabber-shaped projections were thickly formed on the outer surface, was produced. An electron micrograph of the produced nickel powder is shown in FIG. 3. Particle size distribution of the nickel particles was about 1 μm. The produced nickel powder was fine powder.

### EXAMPLE 4

Base liquid including 25 ml of ion-exchange water and 2 g of nickel chloride hexahydrate was firstly prepared. Next, 1.7 g of sodium carbonate was added to the base liquid. Further, NaOH was added. Then, 2 ml of concentrated sulfuric acid was added and NaOH was further added thereto so as to adjust a pH value thereof to about pH 12 with pH test paper (trade name: DUOTEST pH9.5-14), so that an alkaline liquid was produced. The alkaline liquid was stored in an oil bath and maintained at temperature about 60 □, 6 ml of hydrazine hydrate was added. The reductive reaction was terminated within 20 hours, and a large number of the stabber-shaped projections were formed on the surface of each of the nickel particles. Particle size distribution of the nickel particles was 0.5-3 μm. An electron micrograph of the produced nickel powder is shown in FIG. 4.

### EXAMPLE 5

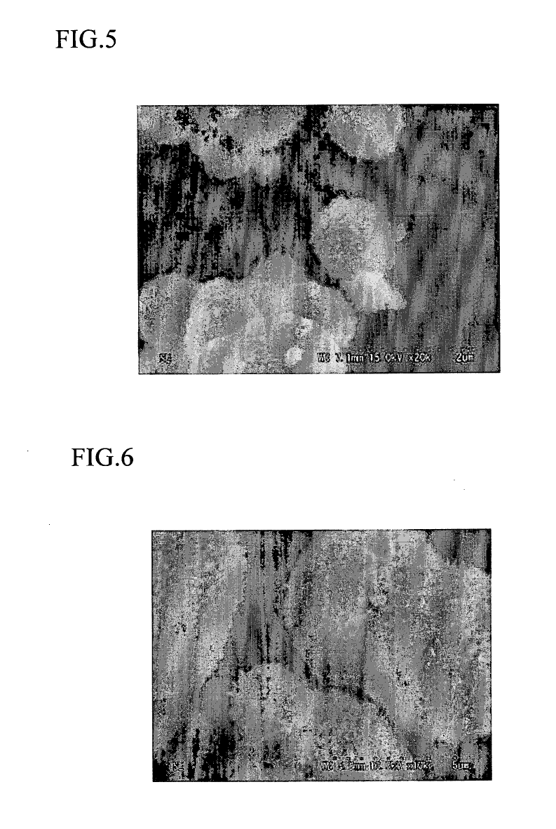

Base liquid including 25 ml of ion-exchange water and 4.3 g of nickel sulfate was firstly prepared. Next, 3.5 g of sodium carbonate was added to the base liquid. Further, NaOH was added thereto. Then, 1 ml of concentrated sulfuric acid and 1 ml of concentrated nitric acid were added thereto, and NaOH was further added so as to adjust a pH value thereof to about pH 12 with pH test paper (trade name: DUOTEST pH9.5-14), so that an alkaline liquid was produced. The alkaline liquid was stored in an oil bath and maintained at temperature about 60 □, 6 ml of hydrazine hydrate was added for the reductive reaction. The reductive reaction was terminated within 10 hours, and a large number of the stabber-shaped projections were formed on the surface of each of the nickel particles. Particle size distribution of the nickel particles was 0.2-2 μm. An electron micrograph of the produced nickel powder is shown in FIG. 5.

### EXAMPLE 6

Base liquid including 25 ml of ion-exchange water and 2 g of nickel chloride hexahydrate was firstly prepared. Next, 0.2 g of sodium sulfate, 0.2 g of potassium nitrate and 1.7 g of sodium carbonate were added to the base liquid. Further, NaOH was added so as to adjust a pH value of the base liquid to about pH 12 with pH test paper (trade name: DUOTEST pH9.5-14), so that an alkaline liquid was produced. Further, 2 ml of concentrated ammonia water was added thereto. The alkaline liquid was stored in an oil bath and maintained at temperature about 60 □, 8 ml of hydrazine hydrate was added for the reductive reaction. The reductive reaction was terminated within five hours, and a large number of the stabber-shaped projections were formed on the surface of each of the nickel particles. Particle size distribution of the nickel particles was 3-8 μm. An electron micrograph of the produced nickel powder is shown in FIG. 6.

### EXAMPLE 7

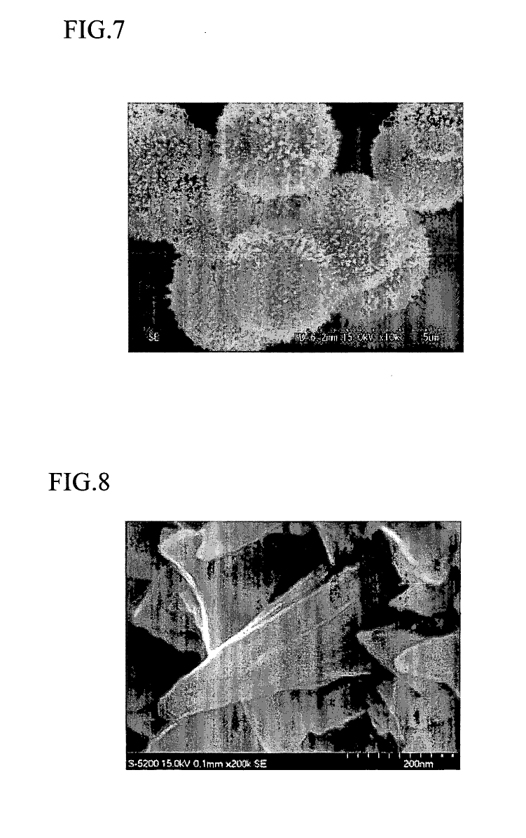

Base liquid including 25 ml of ion-exchange water and 2 g of nickel chloride hexahydrate was firstly prepared. 0.1 ml of concentrated sulfuric acid, 0.1 ml of concentrated nitric acid and NaOH were added to the base liquid so as to neutralize the base liquid. 1.7 g of sodium carbonate was added to the neutralized base liquid, and NaOH was further added so as to adjust the pH value of the base liquid to about pH 12 with pH test paper (trade name: DUOTEST pH9.5-14), so that an alkaline liquid was produced. Further, 2 ml of concentrated ammonia water was added thereto. The alkaline liquid was stored in an oil bath and maintained at temperature about 60 □, 6 ml of hydrazine hydrate was added for the reductive reaction. The reductive reaction was terminated within five hours, and a large number of the stabber-shaped projections were formed on the surface of each of the nickel particles. Particle size distribution of the nickel particles was 4-5 μm. An electron micrograph of the produced nickel powder is shown in FIG. 7, and FIG. 8 is an enlarged photograph thereof.

### EXAMPLE 8

Base liquid including 40 ml of ion-exchange water and 4 g of nickel chloride hexahydrate was firstly prepared.

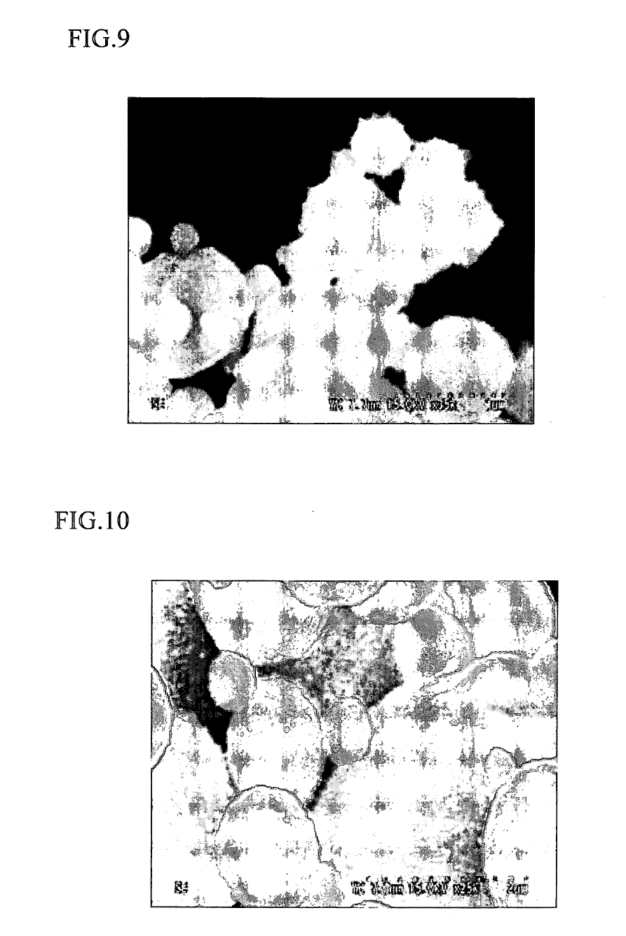

Next, 3.5 g of sodium carbonate and 0.2 g of boric acid was added to the base liquid. Further, 15 ml of a solution of sodium hydrate (4.17 mol/l) was added to the base liquid so as to produce an alkaline liquid, and the alkaline liquid was agitated. The alkaline liquid was stored in an oil bath and maintained at temperature about 60 □, 5 ml of hydrazine hydrate was added for the reductive reaction. The reductive reaction was terminated within five hours, and a large number of the relatively small stabber-shaped projections were formed on the surface of each of the nickel particles. An electron micrograph of the produced nickel powder is shown in FIG. 9.

### EXAMPLE 9

Base liquid including 40 ml of ion-exchange water and 4 g of nickel chloride hexahydrate was firstly prepared.

3.5 g of sodium carbonate and 0.05 mol/l of an EDTA solution were added to the base liquid. Further, 15 ml of a solution of sodium hydrate (4.17 mol/l) was added to the base liquid so as to produce an alkaline liquid, and the alkaline liquid was agitated. The alkaline liquid was stored in an oil bath and maintained at temperature about 60 □, 5 ml of hydrazine hydrate was added for the reductive reaction. The reductive reaction was terminated within five hours, and a large number of the relatively small stabber-shaped projections were formed on the surface of each of the nickel particles. An electron micrograph of the produced nickel powder is shown in FIG. 10.

### EXAMPLE 10

Base liquid including 40 ml of ion-exchange water and 4 g of nickel chloride hexahydrate was firstly prepared.

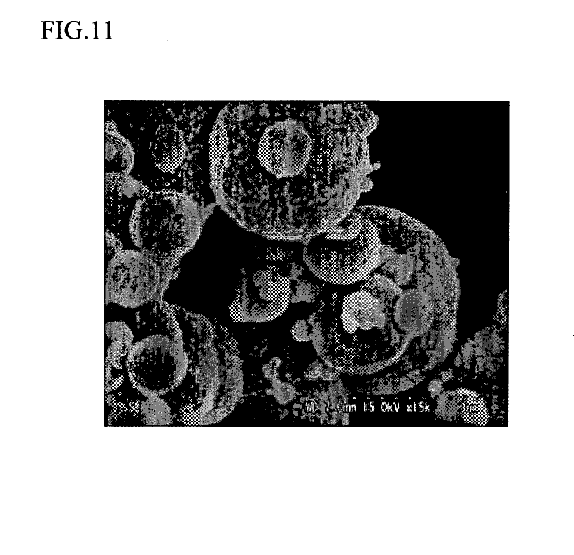

3.5 g of sodium carbonate and 0.3 g of glycine were added to the base liquid. Further, 15 ml of a solution of sodium hydrate (4.17 mol/l) was added to the base liquid so as to produce an alkaline liquid, and the alkaline liquid was agitated. The alkaline liquid was stored in an oil bath and maintained at temperature about 60 □, 5 ml of hydrazine hydrate was added for the reductive reaction. The reductive reaction was terminated within five hours, and a large number of the relatively small stabber-shaped projections were formed on the surface of each of the nickel particles. An electron micrograph of the produced nickel powder is shown in FIG. 11.

In each of the above described Examples, the reductive reaction was accelerated and the reaction time was shortened by previously adding a minute number, e.g., 100, of conventional nickel particles, whose diameters were several Jim, in the base liquid.

Successively, the nickel powder of each Example was mixed with matrix resin, e.g., thermosetting epoxy resin, to form a composite material, which includes 20 wt % of the nickel powder. The composite materials had good electrical conductivity.

Further, the nickel particles of the nickel powder of each Example were electroless-plated with silver, and the nickel powder including the plated nickel particles was mixed with matrix resin to form a composite material. The composite materials had higher electrical conductivity.

The nickel powder of the present invention may be used as not only the above described electrically conductive filler but also an electric contact material, a material for electrodes of a battery, a catalytic agent, additive agents for chemicals, etc.

The invention may be embodied in other specific forms without departing from the spirit of essential characteristics thereof. The present embodiments are therefore to be considered in all respects as illustrative and not restrictive, the scope of the invention being indicated by the appended claims rather than by the foregoing description and all changes which come within the meaning and range of equivalency of the claims are therefore intended to be embraced therein.

What is claimed is:

1. Nickel powder including nickel particles, whose particle diameters are 0.1-10 μm,
wherein each of said nickel particles comprises:
an outer surface; and
a large number of stabber-shaped projections, whose heights are lower than a quarter of the particle diameter, being integrally formed on the outer surface.

2. The nickel powder according to claim 1,
wherein the outer surface of each of said nickel particles is coated with a metal film.

3. A composite material,
comprising:
matrix resin; and
nickel powder including nickel particles, whose particle diameters are 0.1-10 μm and each of which comprises: an outer surface; and a large number of stabber-shaped projections, whose heights are lower than a quarter of the particle diameter, being integrally formed on the outer surface.

4. The composite material according to claim 3,
wherein the outer surface of each of said nickel particles is coated with a metal film.

5. A method of producing nickel powder, which includes nickel particles,
comprising the steps of:
producing base liquid, in which a nickel compound is included as a nickel source;
producing an alkaline liquid by adding alkali and at least one member selected from a group consisting of a sulfate ion source, an ammonia or ammonium ion source, a nitrate ion source and a complexing agent for producing a complex body with nickel to the base liquid; and
reducing nickel particles by warming the alkaline liquid and adding a reducing agent constituted by hydrazine or hydrazine hydrate so as to form the nickel particles, in each of which a large number of stabber-shaped projections are integrally formed on an outer surface.

6. The method according to claim 5,
wherein metal powder or ceramic powder is mixed with the base liquid.

7. The method according to claim 5,
wherein a carbonate ion source is added to the base liquid.

8. The method according to claim 6,
wherein a carbonate ion source is added to the base liquid.

9. The method according to claim 5,
wherein the complexing agent is boric acid, EDTA or glycine.

10. The method according to claim 6,
wherein the complexing agent is boric acid, EDTA or glycine.

11. The method according to claim 7,
wherein the complexing agent is boric acid, EDTA or glycine.

12. The method according to claim 8,
wherein the complexing agent is boric acid, EDTA or glycine.

13. The method according to claim 5,
wherein at least one member selected from a group consisting of a sulfate ion source, an ammonia or ammonium ion source, a nitrate ion source and a complexing agent for producing a complex body with nickel is added after alkali addition.

14. The method according to claim 5,
wherein at least one member selected from a group consisting of a sulfate ion source, an ammonia or ammonium ion source, a nitrate ion source and a complexing agent for producing a complex body with nickel is added before alkali addition.

15. The method according to claim 5,
wherein at least one member selected from a group consisting of a sulfate ion source, an ammonia or ammonium ion source, a nitrate ion source and a complexing agent for producing a complex body with nickel is added before and after alkali addition.

16. The method according to claim 5,
wherein alkali is added before and after at least one member selected from a group consisting of a sulfate ion source, an ammonia or ammonium ion source, a nitrate ion source and a complexing agent for producing a complex body with nickel.

17. The method according to claim 5,
wherein the alkaline liquid is produced by firstly adding at least one member selected from a group consisting of a sulfate ion source, an ammonia or ammonium ion source, a nitrate ion source and a complexing agent for producing a complex body with nickel to the base liquid and further adding alkali thereto, and repeating said two adding processes in that order.

18. The method according to claim 5,
wherein the alkaline liquid is produced by firstly adding alkali to the base liquid and further adding at least one member selected from a group consisting of a sulfate ion source, an ammonia or ammonium ion source, a nitrate ion source and a complexing agent for producing a complex body with nickel thereto, and repeating said two adding processes in that order.
